(19) United States
(12) Patent Application Publication
(10) Pub. No.: US 2024/0260618 A1
(43) Pub. Date: Aug. 8, 2024

(54) MISO PRODUCTION METHOD AND MISO PRODUCTION KIT

(71) Applicant: Erika HIROSE, Susono-shi, Shizuoka (JP)

(72) Inventor: Erika HIROSE, Susono-shi, Shizuoka (JP)

(21) Appl. No.: 18/568,816

(22) PCT Filed: Jun. 6, 2022
(86) PCT No.: PCT/JP2022/022733

§ 371 Date: Dec. 9, 2023

(30) Foreign Application Priority Data
Jun. 11, 2021 (JP) 2021-098161

(51) Int. Cl. A23L 7/104

(52) U.S. Cl. CPC A23L 7/104

(57) ABSTRACT

The present invention provides a method for producing miso and a kit for producing miso that can shorten the fermentation period and very easily produce miso with favorable flavor.

[Resolution Means] The present invention relates to a method for producing miso, including: a step for obtaining a first mixture containing at least a miso raw material, salt, koji, and water; a first fermentation step for fermenting the first mixture to obtain a first fermented product; a step for mixing at least the first fermented product and salt to obtain a second mixture; and a second fermentation step for fermenting the second mixture to obtain a second fermented product, wherein the salt content of the first mixture is lower than the salt content of the second mixture, and miso is further added to the first mixture and/or the second mixture. Furthermore, the present invention relates to a kit for producing miso, including a first composition for obtaining the first mixture and a second composition for obtaining the second mixture.

### TECHNICAL FIELD

The present invention relates to a method for producing miso and a kit for producing the same. In particular, the present invention relates to a method for producing miso and a kit for producing the same that can shorten the fermentation period and very easily produce miso with favorable flavor.

### BACKGROUND ART

Miso is produced by adding koji and salt to a miso raw material made from steamed soybeans, and fermenting and maturing this raw material mixture. Koji is produced by culturing Aspergillus oryzae using steamed rice or the like as a substrate. Rice miso and barley miso, which uses rice or barley instead of soybeans, are also known.

In fermentation, a first stage in which the miso raw material is decomposed by enzymes of Aspergillus oryzae is performed. This initiates a second stage in which microorganisms including lactic acid bacteria and yeast become active, enriching the mixture with glucose, amino acids, peptides, and the like. Lactic acid bacteria produce lactic acid and lower the pH to create an environment in which yeast can easily grow, while also inhibiting the growth of spoiling microorganisms and improving storage stability. Yeast plays an important role in flavor formation by producing ethanol from glucose and higher alcohols from amino acids. After fermentation is completed, a stage of aging through chemical synthesis without the involvement of microorganisms is entered. The flavor of miso is further formed through the combination, decomposition, and polymerization of various substances produced through fermentation. In particular, during the aging process, the color of miso become dark due to the Maillard reaction between sugars and amino acids.

Fermentation is carried out at a temperature of around 30° C., and subsequent aging is also carried out at the same temperature, but at this time, in order to suppress the growth of various bacteria and prevent spoilage, normally about 7 to 13% by mass of salt is added with respect to the total mass of the raw material mixture. By fermenting a raw material mixture containing salt in an amount within this range and further aging such, miso with favorable flavor can be obtained.

The time required to produce miso differs depending on the type of miso, but the time required for fermentation and aging after preparation is long, and for normal miso, this is about 5 to 12 months. The time required for fermentation and aging can be shortened by changing the fermentation temperature, salt content, use of additives, and the like, and various studies have been made to this point.

For example, Patent Document 1 discloses a method for producing miso that uses shochu sediment that has been completely saccharified and fermented as a raw material, thereby significantly shortening the fermentation and aging in the normal miso production process.

Patent Document 2 discloses a method that uses a raw material mixture with low salt content and performs a first fermentation step at a low temperature and a second fermentation step at a high temperature, whereby the proliferation of various bacteria can be suppressed and a favorable flavor of miso can be obtained. With this method, miso can also be produced in a relatively short period of time.

### PRIOR ART DOCUMENTS

### Patent Documents

[Patent Document 1] Japanese Patent Application Publication No. 2013-81
[Patent Document 2] Japanese Patent Application Publication No. 2017-29068

### SUMMARY OF THE INVENTION

### Problem to be Solved by the Invention

An object of the present invention is to provide a method for producing miso and a kit for producing the same, which can shorten the fermentation period compared to the case of producing miso with the same salt content and can very easily produce miso with favorable flavor.

### Means to Solve the Problem

In one embodiment, the present invention is a method for producing miso, including:
a step for obtaining a first mixture containing at least miso raw material, salt, koji, and water;
a first fermentation step for fermenting the first mixture to obtain a first fermented product;
a step for mixing at least the first fermented product and salt to obtain a second mixture; and
a second fermentation step for fermenting the second mixture to obtain a second fermented product,
wherein
the salt content of the first mixture is lower than the salt content of the second mixture, and
miso is further added to the first mixture and/or the second mixture.

According to the method for producing miso, the fermentation period can be shortened because the salt content of the first mixture is relatively low, and because miso is added to the first mixture and/or the second mixture, even when various miso raw materials are used, the flavor of the final miso will be favorable.

Furthermore, in this production method, both the first fermentation step and the second fermentation step can be carried out at room temperature, so they can be easily carried out at home, in restaurants, and the like.

Furthermore, since the production is very easy, even people who do not know much about miso, such as foreigners other than Japanese people, can reproducibly produce miso with favorable flavor.

In a further embodiment, the method of the present invention provides that the first mixture has a salt content of 4.0 to 8.0% by mass and a water content of 30 to 70% by mass. In particular, in the method of the present invention, the salt content relative to the water content of the first mixture is 7.5% by mass to 20.0% by mass.

When the salt content and water content of the first mixture are within such ranges, it is advantageous because spoilage is less likely to occur and the fermentation period can be shortened.

In a further embodiment, the method of the present invention provides that the second mixture has a salt content of 5.5% by mass to 10.0% by mass or less and a water content of 30 to 70% by mass. In particular, in the method of the present invention, the salt content relative to the water content of the second mixture is 10.0% by mass to 20.0% by mass.

When the salt content and water content of the second mixture are within such ranges, it is advantageous because the ultimately obtained miso can have a relatively long expiration date.

In a further embodiment, a total of 2.0 to 15% by mass of miso may be added to the first mixture and/or the second mixture, based on the amount of the second mixture.

It is preferable that the first mixture and the second mixture contain each ingredient in the ranges described above, because miso with favorable flavor can be easily obtained in a short fermentation period.

In a further embodiment, the method of the present invention is a food product in which the miso raw material contains wheat or rice.

This embodiment is advantageous because it is possible to produce miso with favorable flavor even when the miso raw material is a food containing wheat or rice rather than the normally used steamed soybeans.

Particularly in embodiments where the miso raw material is a food containing wheat or rice, the method of the present invention is such that the miso raw material is food waste.

As described above, the method of the present invention can be easily carried out at home, in restaurants, and the like, and according to this embodiment, food loss can be reduced at home, in restaurants, and the like, and is therefore very socially beneficial.

In another embodiment, the present invention is a kit for producing miso for carrying out the method of the present invention described above, which includes a first composition for obtaining the first mixture, and a second composition for obtaining the second mixture.

### Effect of the Invention

According to the present invention, it is possible to provide a method for producing miso and a kit for producing miso that can shorten the fermentation period compared to the case of producing miso with the same salt content and can very easily produce miso with favorable flavor.

### EMBODIMENTS OF INVENTION

### <Method for Producing Miso>

The method for producing miso of the present invention includes: a step for obtaining a first mixture containing at least a miso raw material, salt, koji, and water; a first fermentation step for fermenting the first mixture to obtain the first fermented product; a step for mixing at least the first fermented product and salt to obtain a second mixture; and a second fermentation step for fermenting the second mixture to obtain a second fermented product, wherein the salt content of the first mixture is lower than the salt content of the second mixture, and miso is further added to the first mixture and/or the second mixture.

### <Step for Obtaining the First Mixture>

The first mixture includes at least a miso raw material, salt, koji, and water, but other ingredients may be further mixed. For example, the first mixture may further include seasonings (such as amino acids), alcohol, vitamins, and the like, as long as the advantageous effects of the present invention can be obtained.

Miso may be further added to the first mixture, and when miso is added to the second mixture, no miso need be added to the first mixture. When miso is added to the first mixture, the added miso is distinguished from that produced by fermentation during the process of the method of the present invention. The miso to be added may be a normal commercially available miso or a miso with a favorable flavor, such as the one ultimately obtained by the method of the present invention. By adding miso to the first mixture, miso with favorable flavor can be easily obtained no matter what kind of miso raw material is used. However, preferably, the miso to be added is miso whose fermentation has not been stopped, such as raw miso that has not been pasteurized, miso to which no alcohol has been added, or the like. Thereby, in addition to the koji derived from the first mixture, the added miso can also promote fermentation of the mixture.

When adding miso to the first mixture, the amount of miso added may be set to, for example, a range of 0.1% by mass to 50% by mass, 0.5% by mass to 50% by mass, 1.0% by mass to 30% by mass, 1.5% by mass to 10% by mass, or 2.0% by mass to 5.0% by mass with respect to the total mass of the first mixture. Without being bound by theory, it is believed that when miso is added to the first mixture, microbial activity is initiated early and the fermentation period can be further shortened. In the present specification, the amount of miso added refers to the amount obtained by removing salt content and water content in the miso from the mass of the miso to be added.

Miso raw materials are not particularly limited as long as they can be fermented with koji to become miso, but examples include steamed beans, rice, barley, and other grains; for example, even millet grains such as quinoa can produce miso with favorable flavor, according to the method of the present invention.

In the method of the present invention, the miso raw material may be a food containing wheat or rice, such as bread, pasta, udon, rice, and the like, instead of the normally used steamed soybeans. The type of bread is not particularly limited, and may be a bread such as white bread, koppe bread, rye bread, tacos, naan, dark bread, raisin bread, or French bread, and the rice may be not only white rice but also brown rice. Even when such various miso raw materials are used in this manner, miso with favorable flavor can be produced according to the method of the present invention.

In the method of the present invention, by using food waste from foods such as those described above as raw materials for miso, it is possible to reduce food loss at home, in restaurants, and the like, and is therefore very socially beneficial. Here, food waste refers to surplus food that has been produced in excess of what is needed.

The content based on the dry mass of the miso raw material in the first mixture may be set to, for example, a range of 5% by mass to 50% by mass, 10% by mass to 45% by mass, 15% by mass to 40% by mass, or 20% by mass to 35% by mass with respect to the total mass of the first mixture. Here, the dry mass refers to the mass excluding water content.

The first mixture includes salt, and the salt content of the first mixture is lower than the salt content of the second mixture. Thereby, the first fermentation step can be performed with relatively low salt content, and thus the fermentation period can be shortened compared to the case of producing miso with the same salt content.

Salt plays an important role in the fermentation steps, as it has a significant impact on microbial activity. The salt content in the first mixture may be 2.0% by mass or more, 3.0% by mass or more, 4.0% by mass or more, 5.0% by mass or more, 5.5% by mass or more, 6.0% by mass or more, 6.5% by mass or more, 10.0% by mass or less, 9.0% by mass or less, 8.0% by mass or less, 7.0% by mass or less, 6.5% by mass or less, or 6.0% by mass or less. The salt content in the first mixture may be set to, for example, a range of 2.0% by mass to 10.0% by mass, 4.0% by mass to 8.0% by mass, or 5.0% by mass to 6.5% by mass. With such a salt content, the first fermentation step can be performed in a relatively short fermentation period. In the present specification, when salt content is mentioned, it is calculated not only by the amount of salt added, but also by the salt content of the miso to be added. On the other hand, the salt contained in miso raw material is normally ignored in the present specification, but when the miso raw material contains a significant amount of salt that cannot be ignored, naturally the salt content in the miso raw material is included in the calculation of salt. The salt content contained in the miso raw material is preferably 5.0% by mass or less, 3.0% by mass or less, 2.0% by mass or less, or 1.0% by mass or less with respect to the mass of the miso raw material.

The first mixture contains koji. The koji is not particularly limited as long as Aspergillus oryzae is included, but examples include rice koji, barley koji, and soybean koji. The koji may be used in a dry state, or raw koji that is not dried may be used. These may be produced by normal production methods.

The content of koji in the first mixture may be set to, for example, a range of 5.0% by mass to 40% by mass, 6.0% by mass to 30% by mass, 7.0% by mass to 20% by mass, 8% by mass to 18% by mass, or 10% by mass to 15% by mass in a dry state. When using barley koji or other rice koji, the amount to be added can be determined by converting from the above mass range based on the amount of Aspergillus oryzae in the dried rice koji.

The first mixture contains water content. The water content contained in the first mixture may be derived from other ingredients such as miso raw materials, or may be mixed with water.

Water content plays an important role in fermentation since, during fermentation, enzymes and/or microorganisms play a role in water. The water content in the first mixture may be set to, for example, a range of 20% by mass to 80% by mass, 30% by mass to 70% by mass, 40% by mass to 60% by mass, 45% by mass to 55% by mass, or 47% by mass to 53% by mass.

The amount of salt content relative to the amount of water content in the mixture is also important since enzymes and/or microorganisms play a role in water and the salt is present as an aqueous solution. In the first mixture of the method of the present invention, the salt content relative to the water content can be set to a lower value compared to general methods for producing miso; specifically, the salt content relative to the amount of water content in the mixture may be set to, for example, a range of 5.0% by mass to 25.0% by mass, 7.5% by mass to 20.0% by mass, 8.0% by mass to 15.0% by mass, or 10.0% by mass to 13.0% by mass.

The koji, salt, and water may be added to the first mixture as a salt koji solution. In that case, the liquid salt koji solution may be set to have a mass ratio of koji to water (mass of koji/mass of water) of a range of 0.2 to 1.5, 0.3 to 1.2, 0.4 to 1.0, or 0.5 to 0.7. In addition, the salt content may be set to a range of 3% by mass to 25% by mass, 5% by mass to 20% by mass, 10% by mass to 18% by mass, 12% by mass to 16% by mass, or 13% by mass to 15% by mass. This salt koji solution may be mixed with at least the miso raw material so that the koji, water, and salt have the mass as described above.

### <First Fermentation Step>

The method of the present invention includes a step for fermenting the first mixture after obtaining such. The first fermentation step ferments the first mixture to a significant extent. In the first fermentation step, both the first stage in which the miso raw material is decomposed by enzymes of Aspergillus oryzae and the second stage in which microorganisms including lactic acid bacteria and yeast are active can be performed.

The fermentation conditions in the first fermentation step are not particularly limited as long as the first mixture does not deteriorate and the fermentation proceeds, but, for example, it is possible to simply leave it at room temperature in a place out of direct sunlight. However, it is preferable that the first mixture is thoroughly kneaded and mixed, and it is preferable that the first mixture is mixed regularly.

The temperature and duration of the fermentation step also depend on the salt content of the first mixture; for example, the fermentation temperature may be set to a range of 0° C. to 50° C., 5° C. to 40° C., 10° C. to 35° C., or 15° C. to 30° C. The fermentation period may be set to 1 day to 2 months, 3 days to 1 month, or 1 week to 3 weeks. The fermentation temperature and fermentation period have important effects on fermentation of miso, and well-known art for fermentation conditions of miso can be referenced for such.

### <Step for Obtaining the Second Mixture>

The method of the present invention includes a step for mixing at least salt with the first fermented product obtained as described above to obtain a second mixture. In the second mixture, at least salt is mixed with the first fermented product, but other ingredients may be further mixed therein. For example, the second mixture may be further mixed with miso, koji, salt, water, seasonings (such as amino acids), alcohol, vitamins, and the like, as long as the advantageous effects of the present invention can be obtained.

The salt content added to the second mixture may be set to, for example, a range of 0.1 parts by mass to 5.0 parts by mass, 0.3 parts by mass to 4.0 parts by mass, 0.5 parts by mass to 3.0 parts by mass, 0.8 parts by mass to 2.5 parts by mass, or 1.0 parts by mass to 2.0 parts by mass with respect to 100 parts by mass of the first mixture.

The salt content in the second mixture is higher than the salt content in the first mixture and may be 5.0% by mass or more, 5.5% by mass or more, 6.0% by mass or more, 6.5% by mass or more, or 7.0% by mass or more or may be 15.0% by mass or less, 12.0% by mass or less, 10.0% by mass or less, 9.0% by mass or less, 8.0% by mass or less, or 7.0% by mass. The salt concentration in the second mixture may be set to, for example, a range of 5.0% by mass to 15.0% by mass, 5.5% by mass to 10.0% by mass, or 6.0% by mass to 8.0% by mass. In particular, the upper limit of the salt content in the second mixture is important in shortening the fermentation period.

Miso may be further added to the second mixture, and when miso is added to the first mixture, no miso need be added to the second mixture. The miso added to the second mixture may be the miso described above which is added to the first mixture. By adding miso to the second mixture, miso with favorable flavor can be easily obtained no matter what kind of miso raw material is used.

When adding miso to the second mixture, the amount of miso added may be set to, for example, a range of 0.1 parts by mass to 40 parts by mass, 0.5 parts by mass to 30 parts by mass, 1.0 parts by mass to 20 parts by mass, 2.0 parts by mass to 10 parts by mass, or 3.0 parts by mass to 5.0 parts by mass with respect to 100 parts by mass of the first mixture.

The total amount of miso added to the first mixture and/or the second mixture may be set to, for example, a range of 1.0% by mass to 40% by mass, 1.5% by mass to 20% by mass, 2.0% by mass to 15% by mass, 2.5% by mass to 8% by mass, or 3.0% by mass to 6% by mass based on the mass of the second mixture.

Koji and/or water may be added to the second mixture. The amount of koji and/or water added to the second mixture may be set to, for example, a range of 0.1 parts by mass to 20.0 parts by mass, 0.5 parts by mass to 15.0 parts by mass, 1.0 parts by mass to 10.0 parts by mass, 1.5 parts by mass to 8.0 parts by mass, or 2.0 parts by mass to 5.0 parts by mass with respect to 100 parts by mass of the first mixture, respectively. As is the case in the step for obtaining the first mixture, the koji, salt, and water may be added to the second mixture as a salt koji solution.

The total amount of koji added to the first mixture and/or the second mixture may be set, for example, a range of 3.0% by mass to 50% by mass, 5.0% by mass to 40% by mass, 8.0% by mass to 30% by mass, 10% by mass to 25% by mass, or 12% by mass to 20% by mass based on the mass of the second mixture.

The water content of the second mixture may be set to, for example, a range of 20% by mass to 80% by mass, 30% by mass to 70% by mass, 40% by mass to 60% by mass, 45% by mass to 55% by mass, or 47% by mass to 53% by mass based on the mass of the second mixture.

In the second mixture of the method of the present invention, the salt content relative to the water content can be set to a lower value compared to general methods for producing miso; specifically, the salt content relative to the amount of water content in the second mixture may be set to, for example, a range of 6.0% by mass to 30.0% by mass, 8.0% by mass to 25.0% by mass, 10.0% by mass to 20.0% by mass, or 12.0% by mass to 16.0% by mass.

The total amount of miso raw material added to the first mixture and/or the second mixture is based on the dry mass and may be set to, for example, a range of 10% by mass to 50% by mass, 10% by mass to 40% by mass, 15% by mass to 35% by mass, or 20% by mass to 30% by mass based on the mass of miso ultimately obtained.

### <Second Fermentation Step>

The method of the present invention includes a step for fermenting the second mixture after obtaining such. In the second fermentation step, the second mixture is fermented until a flavor sufficient for miso is developed. In the second fermentation step, aging can proceed simultaneously with fermentation.

The fermentation conditions in the second fermentation step are similar to those in the first fermentation step, but the fermentation period may be shorter than the first fermentation step, for example, 1 day to 1 month, 3 days to 3 weeks, or 1 week to 2 weeks.

After obtaining the second fermented product, the method of the present invention may further include a normal miso aging step. However, according to the method of the present invention, miso with favorable flavor can be produced even without performing the normal aging step.

### <Kit for Producing Miso>

The present invention further relates to a kit for producing miso for use in the above production method. Therefore, for each configuration of the kit for producing miso of the present invention, each configuration described regarding the method for producing of the present invention can be referenced. This kit for producing miso includes at least a first composition for obtaining the first mixture and a second composition for obtaining the second mixture.

It is preferable that the first composition contains all ingredients other than the miso raw material in the first mixture. By doing so, the user of the kit for producing miso can obtain the first mixture by mixing only the miso raw material and the first composition. However, the first composition need not contain at least some ingredients of the first mixture, in which case, the lacking ingredients may be mixed in when obtaining the first mixture. Similarly, the second composition preferably contains all the ingredients of the second mixture other than the first fermented product, but some ingredients need not be included.

The first composition of the kit for producing miso may contain 0% by mass to 50% by mass, 10% by mass to 45% by mass, 20% by mass to 40% by mass, 25% by mass to 35% by mass, or 27% by mass to 33% by mass of koji, 8% by mass to 25% by mass, 10% by mass to 20% by mass, or 12% by mass to 15% by mass of salt content, 30% by mass to 70% by mass, 45% by mass to 65% by mass, or 50% by mass to 60% by mass of water content, 0% by mass to 50% by mass, 1% by mass to 30% by mass, or 2% by mass to 10% by mass of added miso, excluding the salt content and water content thereof.

The second composition of the kit for producing miso may contain 0% by mass to 50% by mass, 5% by mass to 30% by mass, 8% by mass to 20% by mass, or 10% by mass to 15% by mass of koji, 8% by mass to 20% by mass, 9% by mass to 15% by mass, or 10% by mass to 14% by mass of salt content, 10% by mass to 50% by mass, 15% by mass to 35% by mass, or 18% by mass 25% by mass of water, and 0% by mass to 80% by mass, 20% by mass to 70% by mass, or 30% by mass to 60% by mass of added miso, excluding the salt content and water content thereof.

The ratio of the mass of the second composition to the mass of the first composition (mass of second composition/mass of first composition) may be 0.10 or more, 0.20 or more, 0.25 or more, 0.30 or more, or 0.50 or more, and may be 2.0 or less, 1.5 or less, 1.0 or less, 0.80 or less, 0.60 or less, 0.50 or less, or 0.40 or less. For example, this ratio may be 0.20 or more and 1.0 or less, or 0.25 or more and 0.50 or less.

The ratio of the amount of the miso raw material used to the total mass of the first composition and the second composition (mass of the miso raw material/total amount of the first and second compositions) may be 0.1 or more, 0.3 or more, 0.5 or more, 0.7 or more, or 1.0 or more, and may be 10.0 or less, 5.0 or less, 4.0 or less, 3.0 or less, 2.0 or less, 1.5 or less, or 1.0 or less. For example, this ratio may be 0.1 or more and 10 or less, or 0.3 or more and 1.5 or less.

The kit for producing miso preferably includes instructions for carrying out the production method of the present invention as described above. These instructions may be printed directly on the packaging of the miso production kit, may be included as a separate sheet in the packaging of the kit for producing miso, or may only be the URL of the website where the instructions for implementation is located or a code such as a QR code of the linked website.

The present invention will be explained in more detail with reference to the following examples, but the present invention is not limited thereto.

### EXAMPLES

Liquid salt koji (salt content of about 13.8% by mass and water content of about 43.1% by mass) was prepared by adding raw rice koji that had not been dried, salt, and water. 140 grams of this liquid salt koji and 10 grams of commercially available raw miso (approximately 45% water content) were mixed to obtain 150 grams of a first composition. 150 grams of this first composition and 200 grams of finely cut bread (dry mass of about 100 grams) were mixed well to obtain a first mixture (salt content of about 5.8% by mass and water content of about 52% by mass).

The first mixture was stored at room temperature, away from direct sunlight, in a place with little temperature change, and was thoroughly kneaded once a day for about 30 seconds to 1 minute to mix, and this was continued for 2 weeks. Thereby, a first fermented product was obtained. Note that after one week had passed, the shape of the finely cut bread had collapsed, and after two weeks, it had an appearance similar to white miso, although the color of a bread heel was retained a bit.

20 grams of the above liquid salt koji and 30 grams of the above commercially available raw miso were mixed to obtain 50 grams of a second composition (salt content of about 12%). This 50 grams of the second composition was thoroughly mixed with the first fermented product to obtain a second mixture (salt content of about 6.6% by mass and water content of about 48.7% by mass). The second mixture contained a relatively large amount of brown raw miso, which was in a state of being simply mixed with the first fermented product, and the second mixture had a slightly brown color and was approaching the appearance of normal miso.

The second mixture was stored at room temperature, away from direct sunlight, in a place with little temperature change, and was thoroughly kneaded once a day for about 30 seconds to 1 minute to mix, and this was continued for 1 week. As a result, a second fermented product was obtained.

The appearance of the second fermented product thus obtained was not much different from that of commercially available miso, and its flavor was also very favorable for miso.

When raisin bread, cooked rice, quinoa, and the like were used as the miso raw materials under the same conditions as described above, miso with favorable flavor was successfully produced.

Note that when raisin bread was used, miso containing raisins was successfully produced, and when quinoa was used, miso in which the particle shape of quinoa was slightly observable was successfully produced. When rice was used, it contained more water than bread, so the amount of water was adjusted to obtain the first mixture. When the amount of water was not adjusted, the miso contained slightly more moisture.

1. A method for producing miso, including:
a step for obtaining a first mixture containing at least miso raw material, salt, koji, and water;
a first fermentation step for fermenting the first mixture to obtain a first fermented product;
a step for mixing at least the first fermented product and salt to obtain a second mixture; and
a second fermentation step for fermenting the second mixture to obtain a second fermented product,
wherein
the salt content of the first mixture is lower than the salt content of the second mixture, wherein the first mixture has a salt content of 2.0 to 9.0 by mass and a water content of 30 to 70% by mass, and
miso is further added to the first mixture and/or the second mixture.

2. The method for producing miso according to claim 1, wherein the first mixture has a salt content of 4.0 to 8.0% by mass amass.

3. The method for producing miso according to claim 1, wherein the salt content relative to the water content of the first mixture is 7.5% by mass to 20.0% by mass.

4. The method for producing miso according to claim 1, wherein the second mixture has a salt content of 5.5% by mass to 10.0% by mass and a water content of 30 to 70% by mass.

5. The method for producing miso according to claim 1, wherein the salt content relative to the water content of the second mixture is 10.0% by mass to 20.0% by mass.

6. The method for producing miso according to claim 1, wherein a total of 2.0 to 15% by mass of miso is added to the first mixture and/or the second mixture, based on the mass of the second mixture.

7. The method for producing miso according to claim 1, wherein the miso raw material is a food product containing wheat or rice.

8. The method for producing miso according to claim 1, wherein the miso raw material is food waste.

9. A kit for producing miso for use in the method for producing miso according to claim 1, comprising a first composition for obtaining the first mixture and a second composition for obtaining the second mixture.
